(19) United States
(12) Patent Application Publication
(10) Pub. No.: US 2008/0245900 A1
(43) Pub. Date: Oct. 9, 2008

(54) SWITCH-LOCATING MECHANISM OF A FLUID PASSAGE

(76) Inventor: Gordon CHIH, Changhua Hsien (TW)

Correspondence Address: SINORICA, LLC, 528 FALLSGROVE DRIVE, ROCKVILLE, MD, 20850, US

(21) Appl. No.: 12/058,341

(22) Filed: Mar. 28, 2008

(30) Foreign Application Priority Data
Apr. 3, 2007 (TW) 096205395

(51) Int. Cl. B05B 9/01

(52) U.S. Cl. 239/526

(57) ABSTRACT

A switch-locating mechanism of a fluid passage includes a fluid passage including a fluid inlet, a fluid outlet and a valve section disposed between the fluid inlet and the fluid outlet. A force application section is arranged at one end of the valve section for driving the valve section. The switch-locating mechanism is drivingly connected with the valve section so that the valve section is switched between a first valve-closed position and a second valve-opened position and located.

### BACKGROUND OF THE INVENTION

The present invention is related to a switch of a fluid passage, and more particularly to a linearly forcible switch-locating mechanism of a fluid passage.

There are various conventional switch-locating mechanisms of fluid passages, such as faucets and valves of water pipes, gas pipes and oil pipes. Such switch is generally rotationally forced to drive a gate disposed inside the valve for opening/closing a fluid outlet. Such rotational measure is often applied to industrial large-size pipeline to save strength. However, in the case that a rotary switch is applied to a domestic small-size fluid passage, a user often needs to rotate the switch many times for shutting off/turning on the flow. It is quite time-consuming and troublesome to do such work.

FIGS. 1 and 2 show a conventional sprinkling gun including a main body 91 and a switch assembly 92. One end of the main body 91 has a water inlet 911, while the other end of the main body 91 has a water outlet 912. The switch assembly 92 includes a lever handle 921, a rod member 922 and a locating member 923. The lever handle 921 is positioned on outer side of the main body 91. One end of the rod member 922 extends into the main body 91 for unblocking/blocking the water outlet 912. The other end of the rod member 922 is connected with one end of the lever handle 921. The locating member 923 is positioned between the lever handle 921 and the rod member 922 for locating the lever handle 921 in an angular position. Also, the locating member 923 serves to drive the rod member 922 to linearly move so as to unblock/block the water outlet 912. In use, a user needs to hold the handle of the sprinkling gun with one hand and shift the locating member 923 with the other hand to locate the lever handle 921. In other words, the user must use both hands to turn on/shut off the water flow. This is quite inconvenient. Furthermore, in the case that the user holds the sprinkling gun with one hand and holds a sponge block or a brush for cleaning an article, the user needs to drop the sponge block or the brush to shift the locating member 923. This is time-consuming and laborious.

FIGS. 3 and 4 show another type of conventional sprinkling gun. The switch assembly 82 of such sprinkling gun includes a lever handle 821, a rod member 822 and a locating unit 823. The configurations of the lever handle 821 and the rod member 822 are substantially identical to those of the conventional sprinkling gun of FIGS. 1 and 2. The locating unit 823 includes a resilient member 8231, a first rack 8232 and a second rack 8233. The resilient member 8231 is positioned between the lever handle 821 and the rod member 822. One end of the resilient member 8231 is mounted on the sprinkling gun. The first rack 8232 is disposed on the other end of the resilient member 8231. The second rack 8233 is disposed on the rod member 822 corresponding to the first rack 8232. When shifting the lever handle 821, the rod member 822 is pulled. By means of the engagement between the first and second racks 8232, 8233, the rod member 822 is located to turn on the water flow. When shutting off the water flow, the resilient member 8231 is biased to disengage the first and second racks 8232, 8233 from each other. At this time, a spring (not shown) fitted on the rod member 822 pushes the rod member 822 to shut off the water flow. The above structure enables a user to operate the switch with single hand. However, the user must bias the resilient member 8231 with the thumb. This fails to conform to the configuration of human hand. Moreover, the part of the user's hand between the thumb and index finger is opened so that the sprinkling gun is likely to drop down from the user's hand.

### SUMMARY OF THE INVENTION

It is therefore a primary object of the present invention to provide a switch-locating mechanism of a fluid passage. By means of pressing the switch-locating mechanism, the fluid passage can be blocked/unblocked.

It is a further object of the present invention to provide the above switch-locating mechanism of the fluid passage, which is applicable to a sprinkling gun. With the switch-locating mechanism, a user can operate the sprinkling gun and shut off/turn on the water flow with single hand.

According to the above objects, the switch-locating mechanism of the fluid passage of the present invention includes a fluid passage including a fluid inlet, a fluid outlet and a valve section disposed between the fluid inlet and the fluid outlet. A force application section is arranged at one end of the valve section for driving the valve section. The switch-locating mechanism is drivingly connected with the valve section and includes a first block body disposed in the fluid passage between the valve section and the force application section and having a first slide section. The switch-locating mechanism further includes a second block body drivingly connected with the first block body and having a second slide section slidably engaged with the first slide section. The second block body is drivingly connected with the force application section. The force application section includes a resilient member for providing a resilient force. When an external force is applied to the force application section, the valve section is driven. The direction of the resilient force provided by the resilient member is reverse to the external force.

The present invention can be best understood through the following description and accompanying drawings wherein:

### BRIEF DESCRIPTION OF THE DRAWINGS

FIG. 1 is a side view of a conventional sprinkling gun in a shutoff state;

FIG. 2 is a side view according to FIG. 1, in which the sprinkling gun is turned on;

FIG. 3 is a side view of another type of conventional sprinkling gun in a shutoff state;

FIG. 4 is a side view according to FIG. 3, in which the sprinkling gun is turned on;

FIG. 5 is a perspective exploded view of a first embodiment of the present invention, which is applied to a sprinkling gun;

FIG. 6 is a side sectional view of the first embodiment of the present invention;

FIG. 7 is a sectional view of the first embodiment of the present invention, showing that the water flow is shut off;

FIG. 8 is a sectional view according to FIG. 7, in which the water flow is turned on from the shutoff state;

FIG. 9 is a sectional view of the first embodiment of the present invention, showing that the water flow is turned on;

FIG. 10 is a sectional view according to FIG. 9, in which the water flow is shut off from the turned on state;

FIG. 11 is a perspective exploded view of a second embodiment of the present invention, which is applied to a handle of a sprinkling gun;

FIG. 12 is a side sectional view of the second embodiment of the present invention, in which the water flow is turned on;

FIG. 13 is a side sectional view of the second embodiment of the present invention, in which the water flow is shut off;

FIG. 14 is a perspective exploded view of a third embodiment of the present invention, which is applied to a sprinkling gun;

FIG. 15 is a side sectional view of the third embodiment of the present invention, in which the water flow is shut off;

FIG. 16 is a side sectional view according to FIG. 15, in which the water flow is turned on from the shutoff state;

FIG. 17 is a sectional view of the third embodiment of the present invention, showing that the water flow is turned on;

FIG. 18 is a sectional view according to FIG. 17, in which the water flow is shut off from the turned on state; and

FIG. 19 is a perspective view showing that the second embodiment of the present invention is applied to a three-way pipe.

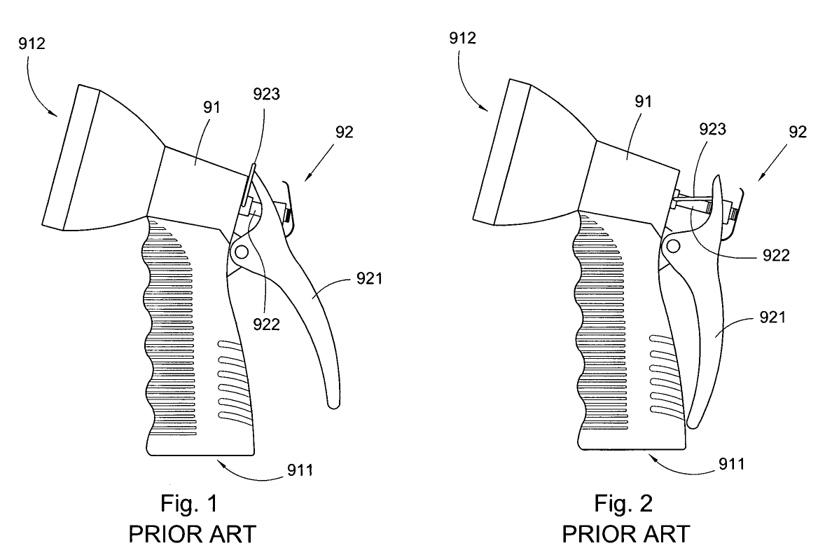

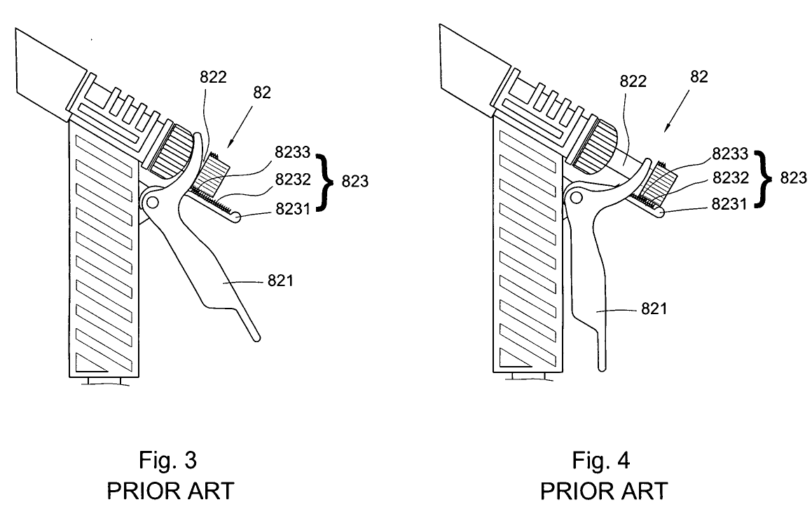

### DETAILED DESCRIPTION OF THE PREFERRED EMBODIMENTS

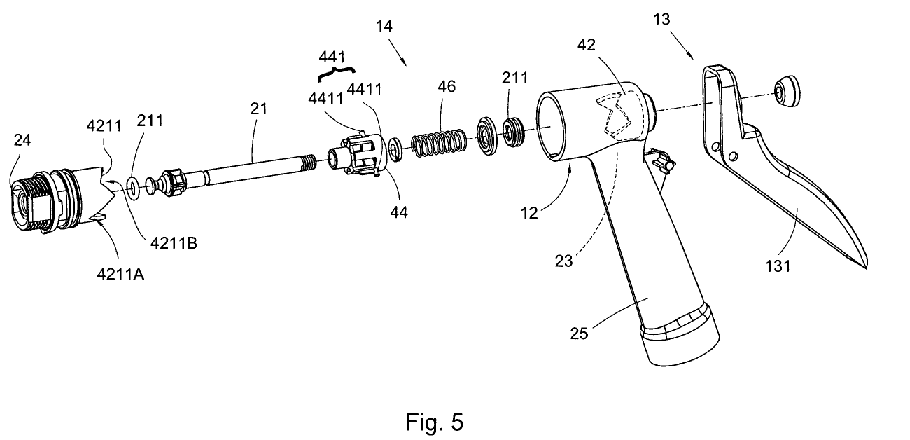

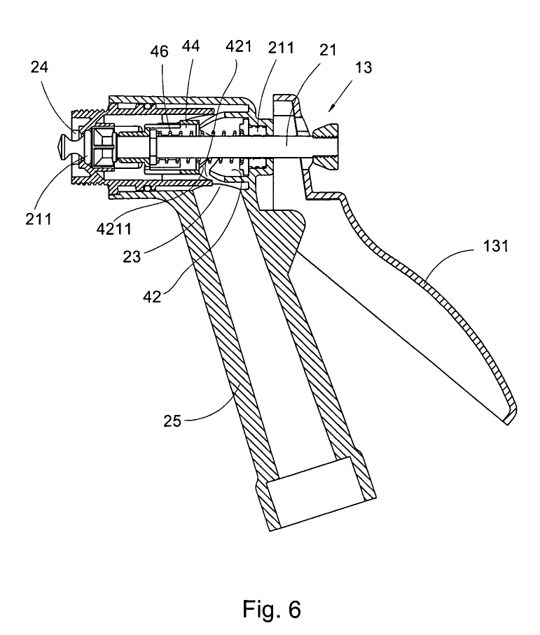

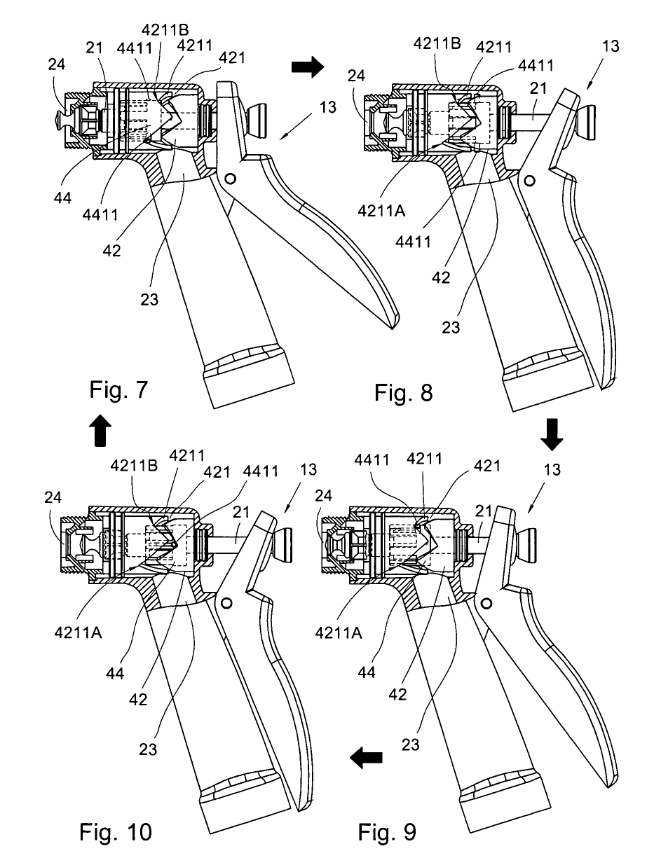

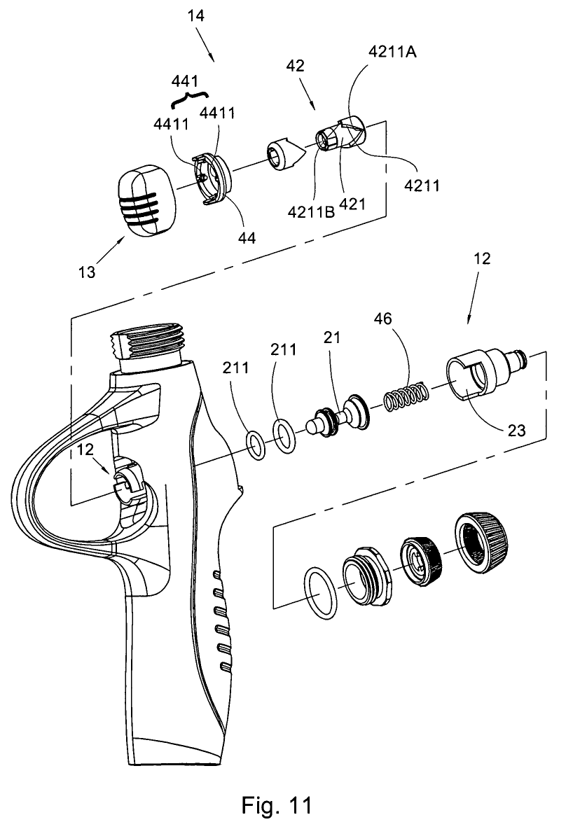

Please refer to FIGS. 5 to 10. The first embodiment of the switch-locating mechanism of the fluid pipeline of the present invention includes a fluid passage 12, a force application section 13 and a switch-locating mechanism 14.

The fluid passage 12 includes a valve section 21, a fluid inlet 23 and a fluid outlet 24. The fluid passage 12 is arranged on a sprinkling gun. The fluid inlet 23 and the fluid outlet 24 are respectively positioned at two ends of the fluid passage 12.

The valve section 21 is disposed between the fluid inlet 23 and the fluid outlet 24. The valve section 21 is a rod member with a certain length. The valve section 21 passes through the fluid passage 12.

The force application section 13 is arranged at one end of the valve section 21. When an external force is manually applied to the force application section 13, the valve section 21 is driven. The force application section 13 includes a coiled spring 32 positioned between the valve section 21 and the fluid passage 12. The coiled spring 32 serves to provide a resilient force in a direction reverse to the external force for driving the valve section 21.

The switch-locating mechanism 14 is drivingly connected with the valve section 21, whereby the other end of the valve section 21 is switched between a first valve-closed position and a second valve-opened position corresponding to the fluid outlet 24. The switch-locating mechanism 14 includes a first block body 42 and a second block body 44.

The first block body 42 is disposed in the fluid passage 12 between the valve section 21 and the force application section 22. The first block body 42 has a first slide section 421.

The first block body 42 is a hollow cylindrical body fixedly disposed on inner wall face of the fluid passage 12 about a rotary axis. The first slide section 421 is formed of a saw-tooth slide way annularly disposed on outer circumference of the first block body 42. The slide way has two lateral faces 4211. One of the lateral faces 4211 closer to the fluid outlet 24 has at least two recesses 4211A, 4211B in different positions in the direction of the rotary axis.

The second block body 44 is a cylindrical body fitted in the first block body 42 and rotatable about the rotary axis. The second block body 44 has a second slide section 441. One end of the second block body 44 abuts against the valve section 21. When the force application section 22 drives the valve section 21, the second block body 44 is also driven. In other words, the second block body 44 is drivingly connected with the force application section 22.

The second slide section 441 is a pair of bosses 4411 projecting from outer circumference of the second block body 44. The second slide section 441 is slidably engaged with the first slide section 421.

By means of the guide slopes and the recesses 4211A, 4211B of the first slide section 421, when the external force and the resilient force alternately drive the second block body 44, the second block body 44 is rotated in one single direction and reciprocally moved. Accordingly, the second block body 44 is angularly displaced and axially moved so that the valve section 21 is switched between the first and second positions and located to shut off or turn on the water flow.

According to the above arrangement, two leakproof washers 211 are respectively disposed between two ends of the valve section 21 and the fluid passage 12 for achieving better watertight effect.

A handheld handle 25 extends from the position of the fluid inlet 23 of the fluid passage 12. The force application section 13 includes a first lever unit 131 mounted on the handle 25. Accordingly, a user can naturally hold the handle 25 with one hand and the part of the hand between the thumb and the index finger can exert a force on the first lever unit 131 to shut off or turn on the water flow. This meets the requirements of human engineering.

Alternatively, the fluid passage 12 can be applied to a handle of a sprinkling gun, a water pipe, a gas pipe or the like.

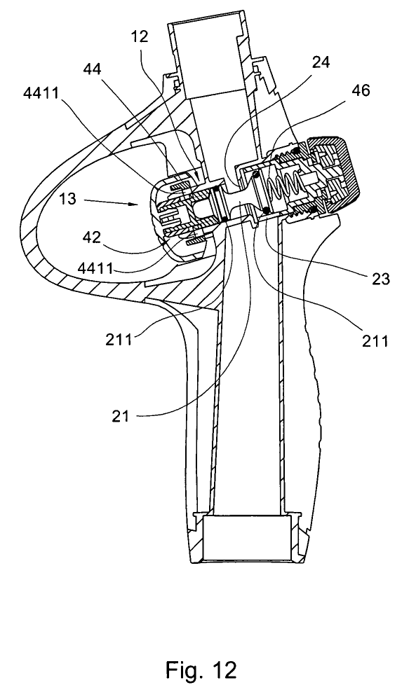

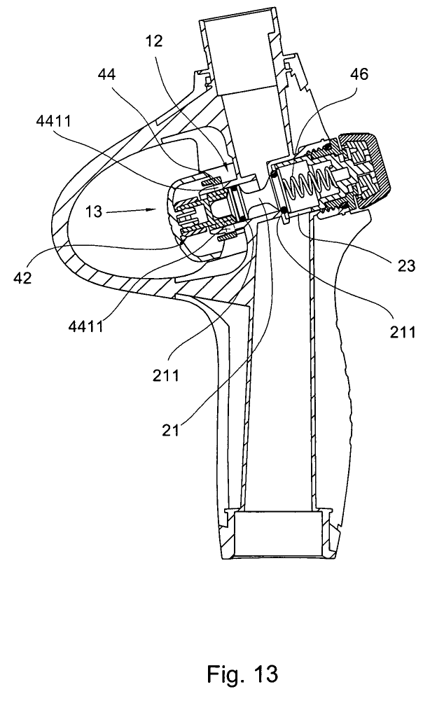

FIGS. 11 to 13 show a second embodiment of the present invention. Basically, the second embodiment is different from the first embodiment in that the first block body 42 of the first embodiment is fixed and unmovable, while the second block body 44 is movable. In contrast to the first embodiment, the second block body 44 of the second embodiment is fixed and unmovable, while the first block body 42 of the second embodiment is movable.

Referring to FIGS. 11 to 13, the second embodiment of the present invention is arranged inside the handle of a sprinkling gun. The valve section 21 is disposed in the fluid passage 12. One end of the valve section 21 is positioned between the fluid inlet 23 and the fluid outlet 24.

A user's finger can press the force application section 13 to exert a force thereon.

The second block body 44 is a hollow block body fixedly fitted through outer wall of the fluid passage 12 about a rotary axis. The second slide section 441 is formed of a pair of bosses 4411 projecting from inner wall face of the second block body 44. The bosses 4411 pass through the fluid passage 12.

The first block body 42 is a cylindrical body fitted in the second block body 44 and rotatable about the rotary axis. The first slide section 421 is slidably engaged with the second slide section 441.

One end of the first block body 42 abuts against the other end of the valve section 21. The force application section 13 is disposed at the other end of the first block body 42. When a force is applied to the force application section 13, both the first block body 42 and the valve section 21 are driven. In other words, the valve section 21 is drivingly connected with the force application section 22. The coiled spring 32 provides resilient force for driving the first block body 42.

The external force and the resilient force alternately drive the first block body 42, whereby the first block body 42 is rotated in one single direction and reciprocally moved. Accordingly, the first block body 42 is angularly displaced and axially moved so that the valve section 21 is switched between the first and second positions and located to shut off or turn on the water flow.

According to the above arrangement, two leakproof washers 211 are respectively disposed between two ends of the valve section 21 and the fluid passage 12 for achieving better watertight effect.

In this embodiment, the force application section 13 is a press button fixedly connected with the first block body 42. Accordingly, the force application section 13 is rotatable with the first block body 42. At least one mark is arranged on outer face of the force application section 13 to indicate the flow or on/off state for a user to conveniently observe.

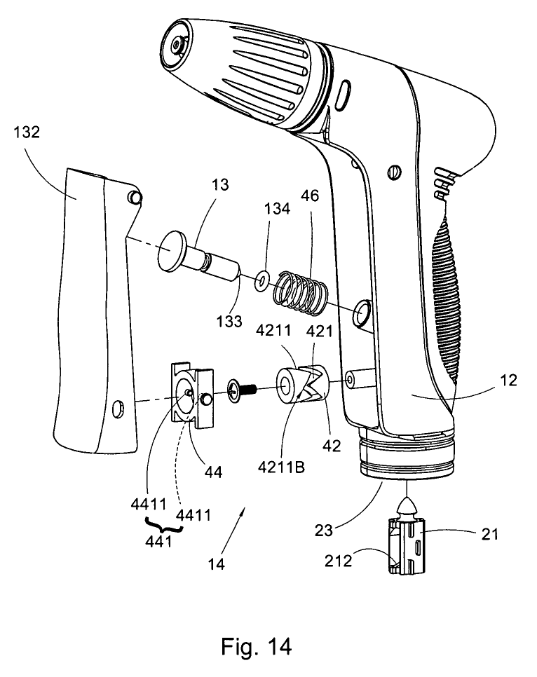

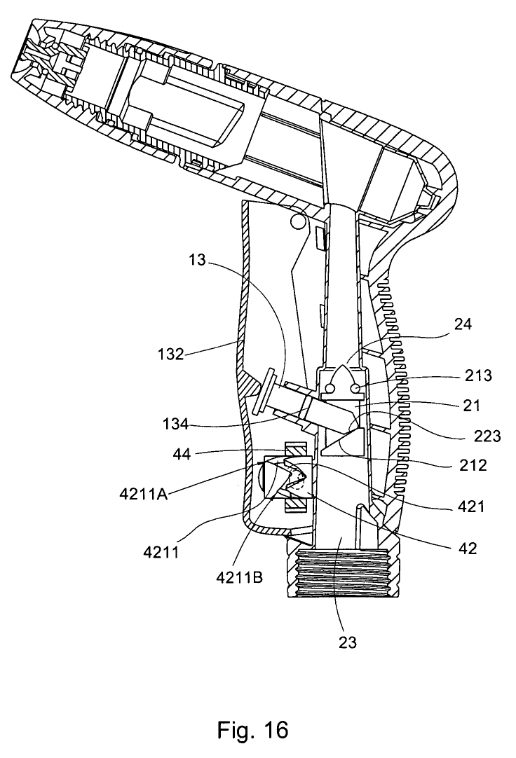

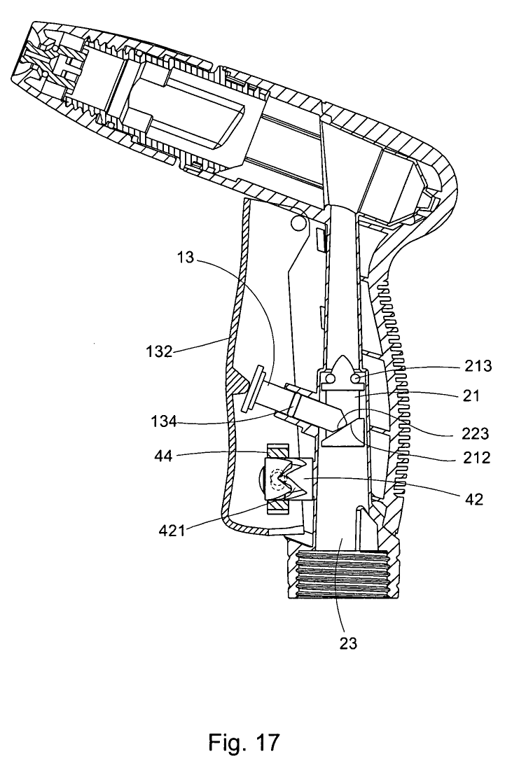

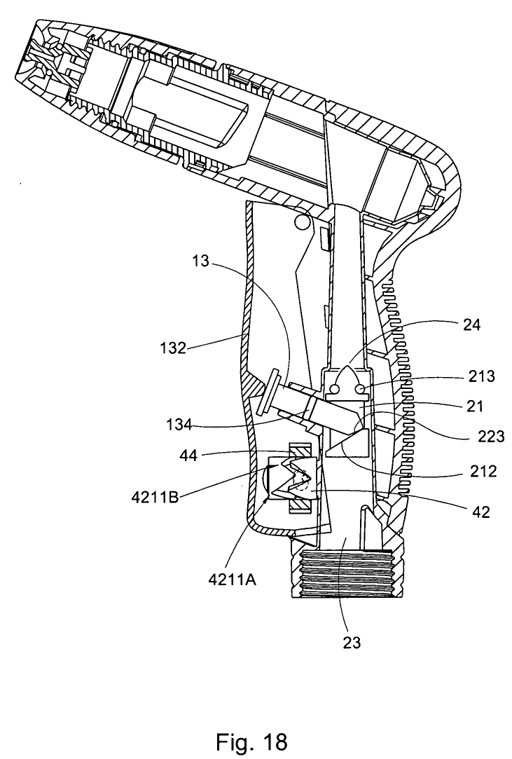

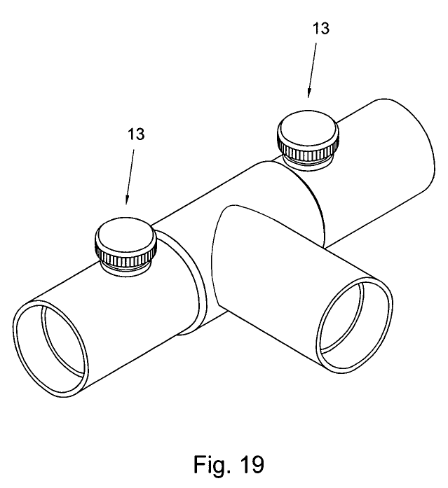

FIGS. 14 to 18 show a third embodiment of the present invention, in which the first block body 42 is movable, while the second block body 44 is rotatable.

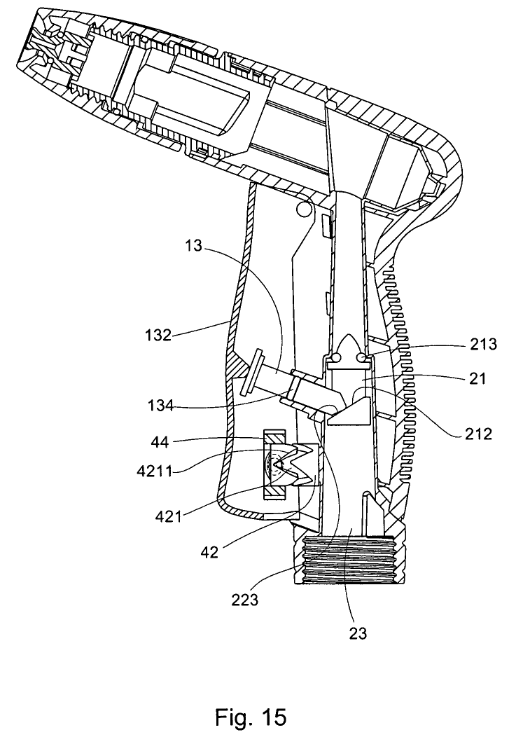

Referring to FIGS. 14 to 18 (in FIGS. 15 to 18, the coiled spring 32 is not shown), the present invention is applied to the handle of a sprinkling gun.

The force application section 13 is a rod member with a certain length. One end of the rod member is reciprocally movably extended into the fluid passage 12. The force application section 13 includes a second lever unit 132 arranged outside the fluid passage 12. The application force end of the lever unit 132 is connected with outer side of the second block body 44. The other end of the force application section 13 is connected with or abuts against the resistance end of the lever unit 132. The coiled spring 32 provides a resilient force for driving the second block body 44.

The first block body 42 is a cylindrical body mounted on outer wall of the fluid passage 12 and rotatable about the rotary axis. The first slide section 421 has two lateral faces 4211. One of the lateral faces 4211 farther from the fluid passage 12 has at least two recesses 4211A, 4211B in different positions in the direction of the rotary axis.

The second block body 44 is a hollow cylindrical body fitted around the first block body 42 about the rotary axis. The second slide section 441 is a pair of bosses 4411 projecting from inner circumference of the second block body 44.

When the external force and the resilient force alternately drive the second block body 44, the second block body 44 is reciprocally moved and the first block body 42 is rotated in one single direction. Accordingly, the second block body 44 is axially displaced so that the valve section 21 is switched between the first and second positions to shut off or turn on the water flow. The valve section 21 is driven by the water flow to move the first valve-closed position.

One end of the valve section 21 corresponding to the fluid outlet 24 is formed as a conic body. The other end of the valve section 21 is formed with a first guide slope 212. One end of the force application section 13 is formed with a second guide slope 133 corresponding to the first guide slope 212. Accordingly, the force application section 13 is able to more conformably drive the valve section 21.

A leakproof washer 213 is disposed around the conic body. Another leakproof washer 134 is disposed between the force application section 13 and the fluid passage 12 for achieving better watertight effect.

FIG. 19 shows that the embodiment of FIGS. 11 to 13 is mounted on a three-way pipe to real-time divide the flow.

Moreover, in the case that the first slide section 421 has more than three recesses in different positions in the direction of the rotary axis, one of the recesses serves to make the valve section 21 located in the first valve-closed position, while the other recesses serve to define different gaps between the valve section 21 and the fluid outlet 24. Accordingly, the present invention can controllably provide different flows.

The above embodiments are only used to illustrate the present invention, not intended to limit the scope thereof. Many modifications of the above embodiments can be made without departing from the spirit of the present invention.

What is claimed is:

1. A switch-locating mechanism of a fluid passage, comprising:
a fluid passage including a valve section, a fluid inlet and a fluid outlet, the valve section being disposed between the fluid inlet and the fluid outlet;
a force application section arranged at one end of the valve section, whereby when an external force is applied to the force application section, the valve section is driven, the force application section including a resilient member for providing a resilient force in a direction reverse to the external force to drive the valve section; and
a switch-locating mechanism drivingly connected with the valve section, whereby the valve section is switched between a first valve-closed position and a second valve-opened position corresponding to the fluid outlet, the switch-locating mechanism including:
a first block body disposed in the fluid passage between the valve section and the force application section, the first block body having a first slide section; and
a second block body drivingly connected with the first block body, the second block body having a second slide section, the first and second slide sections being relatively slidably engaged with each other, the force application section alternately driving the first block body or the second block body, whereby the external force and the resilient force relatively angularly and linearly displace the first and second block bodies and locate the first and second block bodies so that the valve section is switched between the first and second positions and located to shut off or turn on the fluid.

2. The switch-locating mechanism of the fluid passage as claimed in claim 1, wherein:
the valve section is a rod member with a certain length, the valve section passing through the fluid passage, the first block body and the second block body;
the first block body is a hollow cylindrical body fixedly disposed on inner wall face of the fluid passage about a rotary axis, the first slide section being formed of a saw-tooth slide way annularly disposed on outer circumference of the first block body, the slide way having two lateral faces, one of the lateral faces closer to the fluid outlet having at least two recesses in different positions in the direction of the rotary axis;
the second block body is a cylindrical body fitted in the first block body and rotatable about the rotary axis, the second slide section being a pair of bosses projecting from outer circumference of the second block body, the second slide section being slidably engaged with the first slide section; and
by means of the guide slopes and the recesses of the first slide section in different positions, the external force and the resilient force angularly displace and axially move the second block body and locate the second block body so that the valve section is switched between the first and second positions.

3. The switch-locating mechanism of the fluid passage as claimed in claim 2, wherein two leakproof washers are respectively disposed between two ends of the valve section and the fluid passage.

4. The switch-locating mechanism of the fluid passage as claimed in claim 1, wherein a handheld handle extends from the position of the fluid inlet of the fluid passage, the force application section including a lever unit mounted on the handle, which lever unit is a first lever.

5. The switch-locating mechanism of the fluid passage as claimed in claim 2, wherein a handheld handle extends from the position of the fluid inlet of the fluid passage, the force application section including a lever unit mounted on the handle, which lever unit is a first lever.

6. The switch-locating mechanism of the fluid passage as claimed in claim 3, wherein a handheld handle extends from the position of the fluid inlet of the fluid passage, the force application section including a lever unit mounted on the handle, which lever unit is a first lever.

7. The switch-locating mechanism of the fluid passage as claimed in claim 1, wherein:
one end of the valve section is positioned between the fluid inlet and the fluid outlet;
the second block body is a hollow block body fixedly fitted through outer wall of the fluid passage about a rotary axis, the second slide section being formed of a pair of bosses projecting from inner wall face of the second block body, the bosses passing through the fluid passage;
the first block body is a cylindrical body fitted in the second block body and rotatable about the rotary axis, the first slide section being formed of a saw-tooth slide way annularly disposed on outer circumference of the first block body, the slide way having two lateral faces, one of the lateral faces closer to the fluid outlet having at least two recesses in different positions in the direction of the rotary axis, the first slide section being slidably engaged with the second slide section;
one end of the first block body abuts against the other end of the valve section, the force application section being disposed at the other end of the first block body, whereby when the force application section drives the first block body, the valve section is also driven; and
by means of the guide slopes and the recesses of the first slide section in different positions, the external force and the resilient force angularly displace and axially move the first block body and locate the first block body so that the valve section is switched between the first and second positions.

8. The switch-locating mechanism of the fluid passage as claimed in claim 7, wherein two leakproof washers are respectively disposed between two ends of the valve section and the fluid passage.

9. The switch-locating mechanism of the fluid passage as claimed in claim 1, wherein:
the force application section is a rod member with a certain length, one end of the rod member extending into the fluid passage;
the first block body is a cylindrical body mounted on outer wall of the fluid passage and rotatable about a rotary axis, the first slide section being formed of a saw-tooth slide way annularly disposed on outer circumference of the first block body, the slide way having two lateral faces, one of the lateral faces farther from the fluid outlet having at least two recesses in different positions in the direction of the rotary axis;
the second block body is a hollow cylindrical body fitted around the first block body about the rotary axis, the second slide section being a pair of bosses projecting from inner circumference of the second block body; and
by means of the guide slopes and the recesses of the first slide section in different positions, the external force and the resilient force angularly displace the first block body and locate the first block body and axially move the second block body and locate the second block body so that the valve section is switched between the first and second positions.

10. The switch-locating mechanism of the fluid passage as claimed in claim 9, wherein the force application section includes a lever unit arranged outside the fluid passage, the lever unit being a second lever, an application force end of the lever unit being connected with outer side of the second block body.

11. The switch-locating mechanism of the fluid passage as claimed in claim 9, wherein one end of the valve section corresponding to the fluid outlet is formed as a conic body, the other end of the valve section being formed with a first guide slope, one end of the force application section being formed with a second guide slope corresponding to the first guide slope.

12. The switch-locating mechanism of the fluid passage as claimed in claim 10, wherein one end of the valve section corresponding to the fluid outlet is formed as a conic body, the other end of the valve section being formed with a first guide slope, one end of the force application section being formed with a second guide slope corresponding to the first guide slope, the other end of the force application section being disposed at a resistance end of the lever unit.

13. The switch-locating mechanism of the fluid passage as claimed in claim 9, wherein a leakproof washer is disposed between the valve section and the fluid outlet and another leakproof washer is disposed between the force application section and the fluid passage.

14. The switch-locating mechanism of the fluid passage as claimed in claim 10, wherein a leakproof washer is disposed between the valve section and the fluid outlet and another leakproof washer is disposed between the force application section and the fluid passage.

15. The switch-locating mechanism of the fluid passage as claimed in claim 11, wherein a leakproof washer is disposed around the conic body and another leakproof washer is disposed between the force application section and the fluid passage.

16. The switch-locating mechanism of the fluid passage as claimed in claim 12, wherein a leakproof washer is disposed around the conic body and another leakproof washer is disposed between the force application section and the fluid passage.
